(19) United States
(12) Patent Application Publication
(10) Pub. No.: US 2022/0232402 A1
(43) Pub. Date: Jul. 21, 2022

(54) METHOD AND APPARATUS FOR PROVIDING COMMUNICATION IN HIGH-SPEED TRAIN ENVIRONMENT

(71) Applicant: ELECTRONICS AND TELECOMMUNICATIONS RESEARCH INSTITUTE, Daejeon (KR)

(72) Inventors: Jae Su SONG, Daejeon (KR); Seung Kwon BAEK, Daejeon (KR)

(21) Appl. No.: 17/475,598

(22) Filed: Sep. 15, 2021

(30) Foreign Application Priority Data
Jan. 15, 2021 (KR) 10-2021-0006215

(51) Int. Cl. H04W 24/08; H04B 17/318; H04W 76/12; H04W 4/42

(52) U.S. Cl. CPC H04W 24/08; H04W 4/42; H04W 76/12; H04B 17/318

(57) ABSTRACT

An operation method of a terminal including a first relay and a second relay, in a communication system, may include: measuring, by the first relay, a first received signal quality of a first base station connected to the first relay; measuring, by the second relay, a second received signal quality of a second base station connected to the second relay; transmitting, by the first relay, a first PDU to the first base station based on the first received signal quality and the second received signal quality through a first bearer established in the first relay; and transmitting, by the second relay, a second PDU to the second base station based on the first received signal quality and the second received signal quality through a second bearer established in the second relay.

### CROSS-REFERENCE TO RELATED APPLICATION

This application claims priority to Korean Patent Applications No. 10-2021-0006215, filed on Jan. 15, 2021, with the Korean Intellectual Property Office (KIPO), the entire content of which is hereby incorporated by reference.

### BACKGROUND

### 1. Technical Field

The present disclosure relates to a communication technique in a high-speed train environment, and more specifically, to a technique for selective packet duplication transmission of data.

### 2. Description of Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

In order to process wireless data that increases rapidly after commercialization of the fourth generation (4G) communication system (e.g., long term evolution (LTE) communication system or LTE-Advanced (LTE-A) communication system), a fifth generation (5G) communication system (e.g., new radio (NR) communication system) using not only a frequency band (e.g., frequency band of 6 GHz or below) of the 4G communication system but also a frequency band (e.g., frequency band of 6 GHz or above) higher than the frequency band of the 4G communication system is being considered. The 5G communication system may support enhanced Mobile BroadBand (eMBB), Ultra-Reliable and Low Latency Communication (URLLC), and massive Machine Type Communication (mMTC).

The 5G communication system may be working on specifications for extending mobile communication to various industrial fields. One of them may be to support broadband communication services in a high-speed mobile vehicle (e.g., transportation means) such as a high-speed train. Today's high-speed train supports a travel speed of over 500 km/h.

Meanwhile, the 5G communication system may use a very high frequency band such as millimeter wave (mmWave) in order to secure a broadband frequency. However, in the 5G communication system using such a very high frequency band, performance degradation may occur due to a Doppler frequency shift occurring in proportion to a movement speed and the frequency used. In addition, in the 5G communication system, a channel estimation error may occur due to channel characteristics that change rapidly due to the high movement speed. Due to the channel estimation error, the performance of the physical layer operating based on channel information may be degraded. Therefore, the 5G communication system may require technologies for improving mobile communication performance in such the high-speed train environment.

### SUMMARY

Accordingly, exemplary embodiments of the present disclosure are directed to providing communication techniques for a high-speed train environment, which selectively apply a packet duplication transmission scheme.

According to a first exemplary embodiment of the present disclosure, an operation method of a terminal including a first relay and a second relay, in a communication system, may comprise: measuring, by the first relay, a first received signal quality of a first base station connected to the first relay; measuring, by the second relay, a second received signal quality of a second base station connected to the second relay; transmitting, by the first relay, a first protocol data unit (PDU) to the first base station based on the first received signal quality and the second received signal quality through a first bearer established in the first relay; and transmitting, by the second relay, a second PDU to the second base station based on the first received signal quality and the second received signal quality through a second bearer established in the second relay.

Each of the first relay and the second relay may perform functions of a radio link control (RLC) layer, a medium access control (MAC) layer, and a physical (PHY) layer, the first relay and the second relay may share functions of a packet data convergence protocol (PDCP) layer, and the first bearer and the second bearer may be split bearers.

When a packet duplication transmission scheme is used, the first PDU may be equal to the second PDU, and when a split transmission scheme is used, the first PDU may be different from the second PDU.

Each of the first received signal quality and the second received signal quality may be one of a reference signal received power (RSRP) and a reference signal received quality (RSRQ) for a reference signal, the first base station may be a master node, and the second base station may be a secondary node.

When the first received signal quality and the second received signal quality are less than or equal to a first threshold, the first PDU transmitted from the first relay to the first base station may be different from the second PDU transmitted from the second relay to the second base station.

When the first received signal quality and the second received signal quality exceed a first threshold, the first PDU transmitted from the first relay to the first base station may be equal to the second PDU transmitted from the second relay to the second base station.

When the first received signal quality and the second received signal quality exceed a first threshold and a value obtained by subtracting the first received signal quality from the second received signal quality is less than a second threshold, the first PDU transmitted from the first relay to the first base station may be equal to the second PDU transmitted from the second relay to the second base station.

According to a second exemplary embodiment of the present disclosure, an operation method of a first base station in a communication system may comprise: transmitting a first reference signal; receiving a first PDU from a first relay based on a first received signal quality of the first reference signal; and receiving, from a second base station, a second PDU received by the second base station from a second relay based on a second received signal quality of a second reference signal transmitted from the second base station, wherein when the first received signal quality at the first relay and the second received signal quality at the second relay are less than or equal to a first threshold, the first PDU and the second PDU are different, and when the first received signal quality and second received signal quality exceeds the first threshold, the first PDU and the second PDU are same.

The operation method may further comprise transmitting a message including the first threshold before transmitting the first reference signal.

The operation method may further comprise when the first PDU is same as the second PDU, selecting one among the first PDU and the second PDU, and transmitting the one to a core network, and when the first PDU is different from the second PDU, reassembling the first PDU and the second PDU, and transmitting the reassembled PDUs to the core network.

According to a third exemplary embodiment of the present disclosure, a terminal may comprise: a processor; a memory electronically communicating with the processor; and instructions stored in the memory, wherein when executed by the processor, the instructions cause the terminal to: measure, by the first relay, a first received signal quality of a first base station connected to the first relay; measure, by the second relay, a second received signal quality of a second base station connected to the second relay; transmit, by the first relay, a first PDU to the first base station based on the first received signal quality and the second received signal quality through a first bearer established in the first relay; and transmit, by the second relay, a second PDU to the second base station based on the first received signal quality and the second received signal quality through a second bearer established in the second relay.

When the first received signal quality and the second received signal quality exceed a first threshold, the first PDU transmitted from the first relay to the first base station may be equal to the second PDU transmitted from the second relay to the second base station.

When the first received signal quality and the second received signal quality exceed a first threshold and a value obtained by subtracting the first received signal quality from the second received signal quality is less than a second threshold, the first PDU transmitted from the first relay to the first base station may be equal to the second PDU transmitted from the second relay to the second base station.

According to the exemplary embodiments of the present disclosure, when a handover frequently occurs due to mobility of a high-speed train in a high-speed train communication system, it is made possible to transmit packets in duplicate at a time when a handover is highly likely to occur. In particular, according to the exemplary embodiments of the present disclosure, it is made possible to transmit packets in duplicate when necessary so that radio resources are not wasted in the high-speed train communication system.

To this end, the exemplary embodiments of the present disclosure propose a new condition for initiating and terminating the operation of transmitting packets in duplicate. As an example, according to the exemplary embodiments of the present disclosure, it is made possible to selectively apply the packet duplication transmission in an area where a handover occurs in a vehicle terminal or an area in which a signal quality of a radio link is low. Accordingly, the exemplary embodiments of the present disclosure may increase the reliability of wireless backhaul links in the high-speed train environment. In particular, according to the exemplary embodiments of the present disclosure, the reliability of the radio link in the high-speed train environment can be enhanced and a significant decrease in resource utilization efficiency can be prevented.

### BRIEF DESCRIPTION OF DRAWINGS

FIG. 1 is a conceptual diagram illustrating a first exemplary embodiment of a communication system.

FIG. 2 is a block diagram illustrating a communication node in a communication system according to a first exemplary embodiment of the present disclosure.

FIG. 3 is a block diagram illustrating a control plane for EN-DC.

FIG. 4 is a block diagram illustrating a control plane for MR-DC.

FIG. 5 is a block diagram illustrating a data plane protocol for MR-DC on a vehicle terminal side.

FIG. 6 is a block diagram illustrating a data plane protocol for MR-DC on a network side.

FIG. 7 is a block diagram illustrating a network for packet duplication transmission.

FIG. 8 is a conceptual diagram illustrating an example in which PD is applied to CA.

FIG. 9 is a conceptual diagram illustrating an example in which PD is applied to DC.

FIG. 10 is a conceptual diagram illustrating a second exemplary embodiment of a communication system.

FIG. 11 is a conceptual diagram illustrating radio signal qualities for selectively applying packet duplication transmission in a dual relay-based split bearer scheme.

FIGS. 12A and 12B are flowcharts for describing a first exemplary embodiment of a communication method for selectively applying packet duplication transmission in a dual relay-based split bearer scheme.

FIGS. 13A and 13B are flowcharts for describing a second exemplary embodiment of a communication method for selectively applying packet duplication transmission in a dual relay-based split bearer scheme.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication networks. Here, the communication system may be used in the same sense as a communication network.

Throughout the present specification, a terminal may refer to a mobile terminal (MT), mobile station (MS), advanced mobile station (AMS), high reliability mobile station (HR-MS), subscriber station (SS), portable subscriber station (PSS), access terminal (AT), user equipment (UE), and/or the like, and may include all or a part of functions of the MT, MS, AMS, HR-MS, SS, PSS, AT, UE, and/or the like.

In addition, throughout the present specification, a base station may refer to an advanced base station (ABS), high reliability base station (HR-BS), node B, evolved node B (eNodeB), gNodeB, access point (AP), radio access station (RAS), base transceiver station (BTS), mobile multihop relay (MMR)-BS, relay station performing a role of the base station, high reliability relay station (HR-RS) performing a role of the base station, small cell base station, and/or the like, and may include all or part of functions of BS, ABS, HR-BS, nodeB, eNodeB, gNodeB, AP, RAS, BTS, MMR-BS, RS, HR-RS, small cell base station, and/or the like.

On the other hand, in a communication system for a high-speed mobile vehicle such as a high-speed train (HST), there may be a direct communication scheme in which a user terminal in the mobile vehicle communicates directly with an external (e.g., terrestrial) base station and a relay communication scheme in which the user terminal communicates with the base station through a relay terminal installed in the mobile vehicle.

Here, in the direct communication scheme, a penetration loss may occur while a radio signal passes through a vehicle or carriage. Since the material of the carriages is usually metal, most signals may be transmitted through windows. However, since windows are coated with metallic components, the direct communication scheme may generally cause a penetration loss of 10-30 dB. Therefore, the direct communication scheme may have a relatively poor reception performance compared to the relay communication scheme. In addition, in the direct communication scheme, since the user terminal directly communicates with the external base station far away, power consumption of the terminal may be high. Further, in the direct communication scheme, all user terminals should individually perform signaling procedures according to their movements, which includes a handover that occurs when the base station is changed and a tracking area update (TAU) procedure that occurs when a tracking area is changed. In the direct communication scheme, user terminals existing in the same carriage have the same mobility, and thus control procedures related to the mobility may occur at almost the same time in all user terminals. Accordingly, the direct communication scheme may generate a large load on the network due to processing of such the control procedures.

In contrast, the relay communication scheme may be a scheme in which a relay terminal is installed outside a train (mainly, roof) to relay signals between the external base station and the user terminals. Such the relay communication scheme may have a two-step structure of a backhaul link between the external base station and the relay terminal and an access link between the relay terminal and each of the user terminals.

The backhaul link and the access link may be based on the same radio access technology (RAT) or different RATs. The biggest advantage of the relay communication scheme may be that signal attenuation by the train body does not occur. In addition, in the relay communication scheme, various performance degradation factors (e.g., inter-carrier interference due to Doppler Shift, channel estimation error, or the like) that occur depending on the high movement speed of the train may be solved by the relay terminal not the individual user terminals.

In general, as compared to the user terminal, the relay terminal may be expensive equipment in terms of hardware, and thus it may be advantageous to implement high transmission/reception performance. In addition, the relay communication scheme may reduce power consumption by allowing the user terminal to communicate with the relay terminal in a short distance instead of communicating with the external base station far away. Such the relay communication scheme may perform only a single control procedure through the relay terminal instead of performing control procedures (e.g., handover, location registration, location update, etc.) by the individual user terminals in terms of economy of control procedures.

The control procedures through the relay terminal may have the advantage of reducing signaling overhead, but when a radio link failure (RLF) occurs in the relay terminal, it affects a plurality of user terminals. In this reason, the reliability of the relay terminal may need to be guaranteed. In addition, not only the control procedures but also the wireless backhaul link may generally require higher transmission reliability than the access links. Therefore, in the high-speed train environment, the relay communication scheme may require methods for improving the reliability of the wireless backhaul link between the base station and the relay terminal.

As described above, when the user terminal located inside the high-speed train or high-speed mobile vehicle desires to receive mobile communication services, it may become difficult for the user terminal to directly communicate with the terrestrial base station due to a Doppler effect due to high mobility, the penetration loss caused by the body of the high-speed mobile vehicle, and the like. In order to solve the above-described problems, in the high-speed mobile communication system, the scheme in which the relay terminal is installed in the high-speed mobile vehicle and the relay terminal relays signals between the base station and the user terminals in the mobile vehicle may be introduced. In such the structure, the reliability may need to be high because a radio section between the base station and the relay terminal serves as the wireless backhaul.

In general, the high-speed mobile vehicle communication system may adopt a transmission scheme with low resource utilization efficiency in order to increase the reliability of the radio link. The present disclosure proposes a method for increasing the link reliability of the wireless backhaul in the high-speed train environment. In particular, the present disclosure proposes a method for increasing the link reliability and preventing a significant decrease in the resource utilization efficiency.

On the other hand, the standardization for the 3GPP radio access network (RAN) has proposed a high-speed train (HST) scenario as one of deployment scenarios of the 5G NR. In the HST scenario, relay terminals (or antennas) may be installed in the front and rear of the train, respectively, by using a structure in which the length of the entire high-speed trains is about 200-300 m, and each relay terminal may perform communication independently.

In the structure proposed by the HST scenario, since two relay terminals are located far enough away, the two relay terminals operate without interference with each other through beamforming, thereby obtaining twice the transmission performance compared to the case of using only a single relay terminal. In addition, in the structure proposed by the HST scenario, if different data is transmitted through two radio links of the two relay terminals, a double transmission speed may be obtained, and transmission reliability may be increased when the same data transmitted in duplicate.

The former case may correspond to a split transmission scheme using split bearers, and the latter case may correspond to a packet duplication (PD) transmission scheme using split bearers, which are specified in the 3GPP standard. When the structure proposed by the HST scenario operates in the PD transmission scheme, data transmission reliability may be improved, but resource utilization efficiency may be lowered as compared to the case of not using the PD transmission scheme.

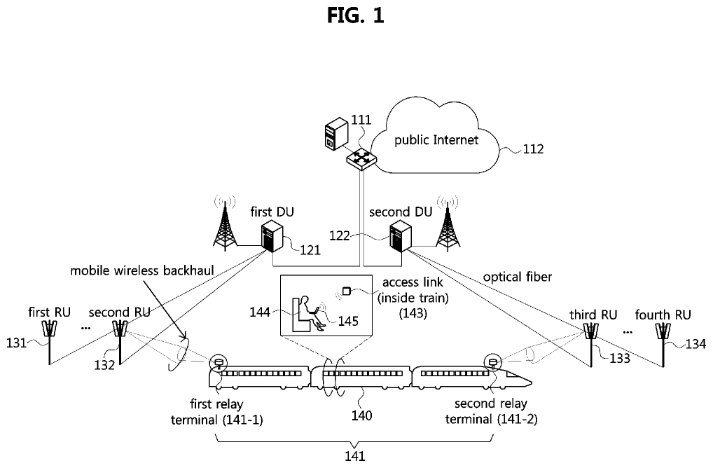

FIG. 1 is a conceptual diagram illustrating a first exemplary embodiment of a communication system.

Referring to FIG. 1, a communication system 100 may include a gateway (GW) 111, a plurality of cloud digital units (CDUs) 121 and 122, a plurality of radio units (RUs) (or, remote radio heads (RRHs)) 131 to 134, a high speed vehicle 140, and the like. Here, the high-speed vehicle 140 may be a high-speed train.

The GW 111 may be included in a core network of the communication system 100. The GW 111 may be connected to the public Internet 112. The GW 111 may be connected to the plurality of CDUs 121 and 122. The GW 111 may control the plurality of CDUs 121 and 122.

The plurality of CDUs 121 and 122 may be connected to the plurality of RUs 131 to 134. For example, the first CDU 121 may be connected to the first RU 131 and the second RU 132 through optical fibers. The first CDU 121 may control the first RU 131 and the second RU 132. In addition, the second CDU 122 may be connected to the third RU 133 and the fourth RU 134 through optical fibers. The second CDU 122 may control the third RU 133 and the fourth RU 134.

A vehicle terminal (or, vehicle equipment) 141 may be disposed outside the high-speed train 140. The vehicle terminal 141 may include a first relay terminal 141-1 and a second relay terminal 141-2. For example, the second relay terminal 141-2 may be disposed on the top of the first vehicle of the high-speed train 140. In addition, the first relay terminal 141-1 may be disposed on the top of the third vehicle of the high-speed train 140. Here, the vehicle terminal may be referred to as a vehicle communication node.

The plurality of relay terminals 141-1 and 141-2 may be connected to the plurality of RUs 131 to 134 through a mobile wireless backhaul network. For example, the first relay terminal 141-1 may be connected to the first RU 131 and the second RU 134 through mobile wireless backhaul links. In addition, the second relay terminal 141-2 may be connected to the third RU 133 and the fourth RU 134 through mobile wireless backhaul links.

An access point (AP) 143 may be disposed inside the high-speed train 140. For example, the AP 143 may be a femto cell or an access point for wireless fidelity (Wi-Fi). The AP 143 may be connected to the plurality of relay terminals 141-1 and 141-2. The plurality of relay terminals 141-1 and 141-2 may provide high-speed mobile wireless backhaul links to the AP 143 by performing communication with the plurality of RUs 131 to 134.

The AP 143 may provide an access link for a user terminal 145 carried by a passenger 144. For example, the AP 143 may provide a high-speed mobile Internet service to the passenger 144 through the user terminal 145.

Here, the user terminal 145 may not directly communicate with the plurality of RUs 131 to 134. That is, the user terminal 145 may be indirectly connected to the plurality of RUs 131 to 134 through the AP 143 connected to the plurality of relay terminals 141-1 and 141-2. Accordingly, the user terminal 145 may overcome radio wave attenuation that may occurs due to outer walls of the high-speed train 140.

In addition, a plurality of user terminals located inside the high-speed train 140 may perform a group handover through the plurality of relay terminals 141-1 and 141-2 at cell edges of the plurality of RUs 131 to 134. For example, the user terminal 145 may perform a group handover through the plurality of relay terminals 141-1 and 141-2. Accordingly, a huge handover signaling overhead, which may occur when a plurality of user terminals individually and simultaneously perform handover procedures, may be prevented.

Here, the plurality of RUs 131 to 134 may have respective cell identifiers (IDs). Accordingly, not only a handover between RUs connected to different CDUs, but also a switching between RUs connected to the same CDU may be possible. For example, the handover between the second RU 132 connected to the first CDU 121 and the third RU 133 connected to the second CDU 122 as well as the switching between the first RU 131 and the second RU 132 connected to the first CDU 121 may be possible.

In addition, the plurality of relay terminals 141-1 and 141-2 may be easily implemented because there is no significant limitation in the implementation of hardware miniaturization, etc. compared to the user terminal 145. In addition, since the user terminal 145 can receive services by using a commercialized communication technology through the AP 143, an additional upgrade may be omitted.

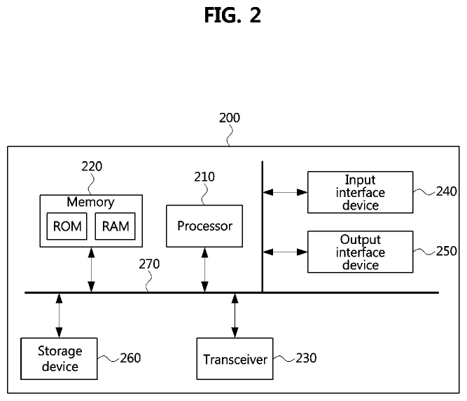

The structures of the GW 111, the plurality of CDUs 121 and 122, the plurality of RUs 131 to 134, the plurality of relay terminals 141-1 and 141-2, the AP 143, and the user terminal 145 will be described with reference to FIG. 2 below.

FIG. 2 is a block diagram illustrating a communication node in a communication system according to a first exemplary embodiment of the present disclosure.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Meanwhile, in order to satisfy both the robustness required in a control plane and the capacity increase required in a user plane, the 3GPP specifications have defined a dual-connectivity (DC) structure wherein a vehicle terminal is connected to two base stations (eNB or gNB) at the same time. The DC may also be referred to as multi-connectivity (MC) in consideration of the form of being connected to two or more base stations. In addition, the DC may be referred to as ‘multi-radio dual connectivity (MR-DC)’ by being extended to interworking between the vehicle terminal and RATs (e.g., WiFi) other than the 3GPP RAT (e.g., LTE or NR).

The plurality of base stations supporting DC functions for the vehicle terminal (e.g., the plurality of base stations connected to the vehicle terminal) may be classified into a master base station and a secondary base station according to the performed function(s) thereof. The master base station may be referred to as a master node (MN), and the secondary base station may be referred to as a secondary node (SN).

In addition, the 3GPP standard has proposed a non-standalone (NSA) structure for operator desiring rapid commercialization, in which the NR technology is used together with the conventional LTE system, and a standalone (SA) structure in which the NR technology is used together with a new network structure.

In the NSA structure, an evolved packet core (EPC) may be used as a core network (CN), an LTE base station (i.e., eNB) may be used as the MN, and an NR base station (i.e., gNB) may be used as the SN. The DC for the above-described NSA structure may be referred to as an evolved universal mobile telecommunications system (UMTS) terrestrial radio access (E-UTRA) new-radio dual connectivity (EN-DC). The MN may be defined as a radio access network (RAN) node that provides a connection for accessing the control plane to the CN, and the SN may be defined as a RAN node for providing additional user plane resources to the vehicle terminal without a connection for accessing the control plane.

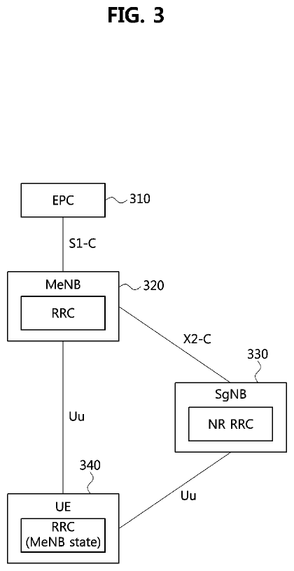

FIG. 3 is a block diagram illustrating a control plane for EN-DC.

Referring to FIG. 3, the control plane for EN-DC may include an EPC 310, a MeNB 320 that is a master eNodeB, an SgNB 330 that is a secondary gNodeB, and a UE 340.

Here, the EPC 310 may be a core network of an Internet Protocol (IP) mobile communication system for the 3GPP LTE system, and may support packet-based real-time and non-real-time services. The EPC 310 may include a serving gateway (SGW or S-GW), a packet data network (PDN) gateway (PGW or P-GW), a mobility management entity (MME), a serving general packet radio service (GPRS) supporting node (SGSN), and an enhanced packet data gateway (ePDG).

In addition, the MeNB 320 may be a device that provides a radio interface to the UE 340, and may provide radio resource management functions such as radio bearer control, radio admission control, dynamic radio resource allocation, load balancing, and inter-cell interference control. The user plane of the SgNB 330 may be associated with the core network, and the control plane of the SgNB 330 may be associated with the core network through the MeNB 320. The MeNB 320 may be associated with the MME of the EPC 310 via an S1-C interface.

The UE 340 may be connected to the MeNB 320 and the SgNB 330 via Uu interfaces. Here, in the Uu interface as a radio interface, the control plane for transmitting and receiving control messages and the user plane for providing user data may be defined.

In the above-described configuration, the MeNB 320 may create an S1-MME control connection with the control entity MME of the EPC 310 that is the core of the LTE system, and relay control message transmission and reception between the MME and the UE 340. In addition, the MeNB 320 may create an RRC connection with the UE 340 by using the LTE radio technology, and may manage an RRC state based on the connection.

Meanwhile, the UE 340 may establish bearers by being connected to the EPC 310 via the MeNB 320. The MeNB 320 may establish bearers for the UE 340, and the UE 340 may be in an RRC connection state with the MeNB 320. In this state, the MeNB 320 may determine whether to use DC for the UE 340 in consideration of a current congestion state, a data transmission/reception state of the UE 340, existence of a gNB that will serve as an SN around the eNB, a congestion state of the gNB, and/or the like.

When the MeNB 320 determines to use DC for the UE 340, the MeNB 320 may transmit and receive X2-C control messages with the SgNB 330 via an X2 interface. In addition, the MeNB 320 may execute a procedure of changing some of the bearers being serviced to the UE 340 through LTE radio resources, to be serviced via the SgNB 330.

In the above-described EN-DC control plane structure, the RRC protocol may exist in both the MeNB 320 and the SgNB 330, but the UE 340 may follow the RRC state of the MeNB 320. Also, there may be only one control plane connection of the CN for the UE 340.

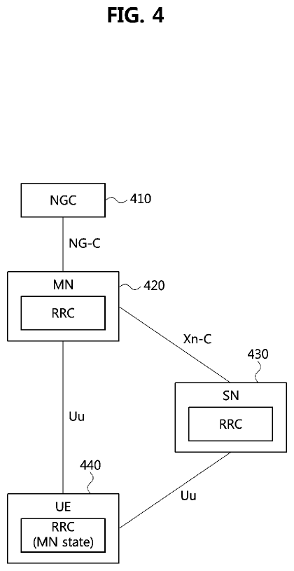

FIG. 4 is a block diagram illustrating a control plane for MR-DC.

Referring to FIG. 4, the control plane for MR-DC may include a new radio core (NGC) 410, an MN 420 that is a master node, and an SN 430 that is a secondary node, and a UE 440.

Here, the NGC 410 may manage 5G communication of the UE 440, and may support packet-based real-time and non-real-time services. In addition, the MN 420 may be a device that provides a radio interface to the UE 440, and may provide radio resource management functions such as radio bearer control, radio admission control, dynamic radio resource allocation, load balancing, and inter-cell interference control. The user plane of the SN 430 may be associated with the NGC 410, and the control plane of the SN 430 may be associated with the NGC 410 via the MN 420. The MN 420 may be associated with the NGC 410 via an NG-C interface.

The UE 440 may be connected to the MN 420 and the SN 430 via Uu interfaces. Here, the Uu interface may be a radio interface defining the control plane for transmitting and receiving control messages and the user plane for providing user data.

In the above-described configuration, the MN 420 may relay transmission and reception of messages between the NGC 410 and the UE 440. In addition, the MN 420 may create an RRC connection with the UE 440 by using the 5G communication technology, and may manage an RRC state based on the connection.

In the above-described MR-DC control plane structure, the RRC protocol may exist in both the MN 420 and the SN 430, but the UE 440 may follow the RRC state of the MN 420. Also, there may be only one control plane connection of the CN for the UE 440.

In the MR-DC structure, when viewed from the vehicle terminal, three bearer types (i.e., master cell group (MCG) bearer, secondary cell group (SCG) bearer, and split bearer) may exist. On the other hand, when viewed from the network, each bearer type may be further classified into two types depending on whether a termination point of the bearer is the MN or the SN, and thus a total of six bearer types may exist.

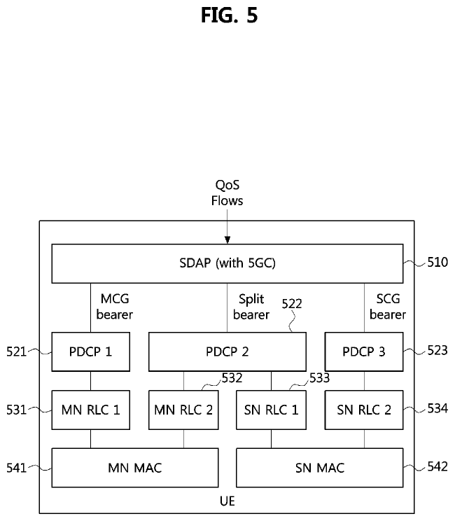

FIG. 5 is a block diagram illustrating a data plane protocol for MR-DC on a vehicle terminal side.

Referring to FIG. 5, the data plane protocol structure for MR-DC on the vehicle terminal side may include a SDAP layer 510, a first packet data convergence protocol (PDCP) layer 521 for supporting MCG bearer(s), a second PDCP layer 522 for supporting split bearers, a third PDCP layer 523 for supporting SCG bearer(s), a first MN radio link control (RLC) layer 531 for supporting the MCG bearer(s), a second MN RLC layer 532 for supporting the split bearers, a first SN RLC layer 533 for supporting the split bearers, a second RLC layer 534 for supporting the SCG bearer(s), an MN medium access control (MAC) layer 541 for supporting the MCG bearer(s) and a part of the split bearers, and an SN MAC layer 542 for supporting the SCG bearer(s) and a part of the split bearers.

In the vehicle terminal having such the MR-DC structure, the second PDCP layer 522 may generate PDCP protocol data units (PDUs) for data to be transmitted in order to transmit the data in the split transmission scheme by using the split bearers. Then, the second PDCP layer 522 may split the PDCP PDUs into PDCP PDUs to be transmitted to the MN and PDCP PDUs to be transmitted to the SN, deliver the PDCP PDUs to be transmitted to the MN to the second MN RLC layer 532, and deliver the PDCP PDUs to be transmitted to the SN to the first SN RLC layer 533. Then, the second MN RLC layer 532 may transmit the PDCP PDUs to the MN through the MN MAC layer, and the first SN RLC layer 533 may transmit the PDCP PDUs to the SN through the SN MAC layer.

On the other hand, in order for the vehicle terminal having the above-described data plane protocol structure for MR-DC to transmit data in the PD transmission scheme by using the split bearers, the second PDCP layer 522 may generate PDCP PDUs for the data to be transmitted. In addition, the second PDCP layer 522 may deliver the PDCP PDUs to the second MN RLC layer 532, and may deliver the same PDCP PDUs to the first SN RLC layer 533. Then, the second MN RLC layer 532 may transmit the PDCP PDUs to the MN through the MN MAC layer, and the first SN RLC layer 533 may transmit the same PDCP PDUs to the SN through the SN MAC layer.

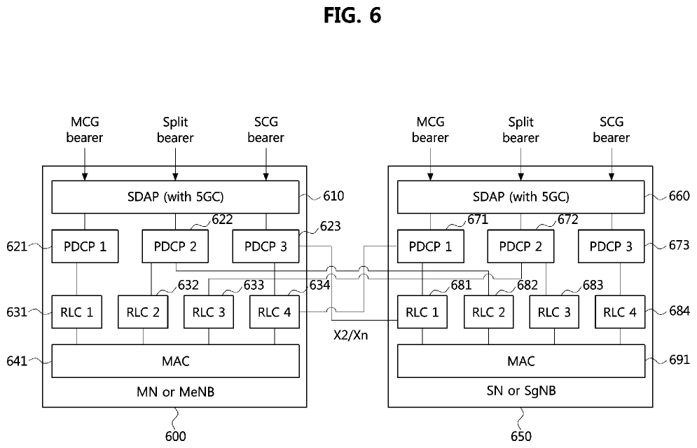

FIG. 6 is a block diagram illustrating a data plane protocol for MR-DC on a network side.

Referring to FIG. 6, the data plane protocol structure for MR-DC on the network side may include a data plane protocol structure 600 of an MN or MeNB and a data plane protocol structure 650 of an SN or SgNB.

Here, the data plane protocol structure 600 of the MN or MeNB may include a SDAP layer 610 for supporting MCG bearer(s), split bearers, and SCG bearer(s), a first PDCP layer 621 for supporting the MCG bearer(s), a second PDCP layer 622 for supporting the split bearers, a third PDCP layer 623 for supporting the SCG bearer(s), a first RLC layer 631 for supporting the MCG bearer(s), second and third RLC layers 632 and 633 for supporting the split bearers, a fourth RLC layer 634 for supporting the SCG bearer(s), and an MN MAC layer 641 for supporting the MCG bearer(s), the split bearers, and the SCG bearer(s).

In addition, the data plane protocol structure 650 of the SN or SgNB may include a SDAP layer 660 for support MCG bearer(s), split bearers, and SCG bearer(s), a first PDCP layer 671 for supporting the MCG bearer(s), a second PDCP layer 672 for supporting the split bearers, a third PDCP layer 673 for supporting the SCG bearer(s), a first RLC layer 681 for supporting the MCG bearer(s), second and third RLC layers 682 and 683 for supporting the split bearers, a fourth RLC layer 684 for supporting the SCG bearer(s), and an MN MAC layer 691 for supporting the MCG bearer(s), the split bearers, and the SCG bearer(s).

In the above-described structure, the second PDCP layer 622 of the data plane protocol structure 600 of the MN or MeNB may be connected to the second RLC layer 682 of the data plane protocol structure 650 of the SN or SgNB via an X2/Xn interface. In addition, in the above-described structure, the third PDCP layer 623 of the data plane protocol structure 600 of the MN or MeNB may be connected to the first RLC layer 681 of the data plane protocol structure 650 of the SN or SgNB via an X2/Xn interface.

Similarly, the first PDCP layer 671 of the data plane protocol structure 650 of the SN or SeNB may be connected to the fourth RLC layer 634 of the data plane protocol structure 600 of the MN or MeNB via an X2/Xn interface. In addition, in the above-described structure, the second PDCP layer 672 of the data plane protocol structure 650 of the SN or SgNB may be connected to the third RLC layer 633 of the data plane protocol structure 600 of the MN or MeNB via an the X2/Xn interface.

Meanwhile, the main functions of the SDAP layers 510, 610, and 650 may include some of the following functions. Of course, they may not be limited to the following examples.
Transfer of user plane data
Mapping between a QoS flow and a data radio bearer (DRB) for both DL and UL
Marking QoS flow ID in both DL and UL packets
Reflective QoS flow to DRB mapping for the UL SDAP PDUs

With respect to the SDAP layer, the terminal may be instructed through an RRC message from the base station whether to use a header of the SDAP layer or whether to use the function of the SDAP layer for each PDCP layer, each bearer, or each logical channel. When the SDAP header is configured, a 1-bit indicator (e.g., non-access stratum (NAS) reflective quality of service (QoS)) and a 1-bit indicator (e.g., access stratum (AS) reflective QoS) in the SDAP header may indicate to the terminal whether to update or reconfigure mapping information for uplink and downlink QoS flows and data bearers. The SDAP header may include QoS flow ID information indicating a QoS. The QoS information may be used as data processing priority, scheduling information, or the like to support smooth service provisioning.

In addition, the PDCP layers 521 to 523, 621 to 623, and 671 to 673 may be in charge of operations such as IP header compression/decompression. The main functions of the PDCP layer may be summarized as follows, and may not be limited to the following examples.
Header compression and decompression: robust header compression (ROHC) only
Transfer of user data
In-sequence delivery of upper layer PDUs at PDCP re-establishment procedure for RLC acknowledge mode (AM)
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The RLC layers 531 to 534, 631 to 634, and 681 to 684 may perform automatic repeat request (ARQ) operations by reconfiguring the PDCP PDU to an appropriate size. The main functions of the RLC layer may be summarized as follows, and may not be limited to the following examples.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

In addition, the MAC layers 541, 542, 641, and 691 may be connected to several RLC layers, may multiplex RLC PDUs in a MAC PDU, and may perform an operation of demultiplexing RLC PDUs from a MAC PDU. The main functions of the MAC layers may be summarized as follows, and may not be limited to the following examples.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

Meanwhile, the 3GPP 5G standard Release-15 includes various features to support the ultra-reliable low-latency communication (URLLC) services. The various features may include a packet duplication transmission function considered in the layer 2 (L2). This may be a type of selection diversity based URLLC technique, in which two independent RBs are established in the PDCP layer, and the same PDCP PDU is transmitted through the two RBs. In this case, even when a packet loss occurs in one RB, the packet may be successfully received in the other RB. From a theoretical point of view, the packet duplication transmission may be based on the reliability theory.

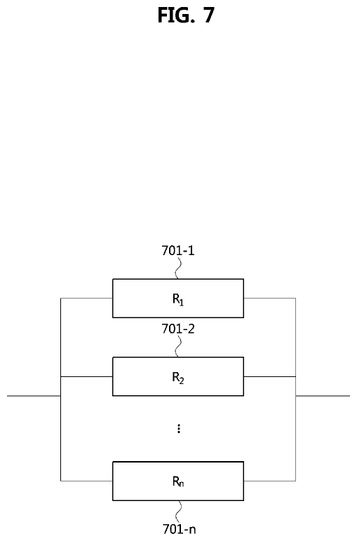

FIG. 7 is a block diagram illustrating a network for packet duplication transmission.

Referring to FIG. 7, a network for packet duplication transmission may have N radio links (i.e., R₁ to Rₙ) 701-1 to 701-n each having an independent channel environment. Here, n and N are natural numbers, and 1≤n≤N may be established.

Assuming that the same data is transmitted through the N radio links 701-1 to 701-n each having an independent channel environment, the overall reliability R of the radio links 701-1 to 701-n may be calculated as shown in Equation 1 below.

$$R = 1 - {\prod }_{i = 1}^{N} ( 1 - {R}_{j} ) \qquad [ Equation 1 ]$$

Here, N may be the number of the independent radio links 701-1 to 701-n, and Rᵢ may be a transmission reliability of the radio link i. The independent radio links 701-1 to 701-n may use different frequencies. Alternatively, the independent radio links 701-1 to 701-n may be obtained by generating the radio links 701-1 to 701-n through different base stations.

That is, in order to implement the packet duplication transmission, it is necessary to establish two independent RBs. In the 3GPP standard, the dual connectivity (DC) and carrier aggregation (CA) schemes may be considered.

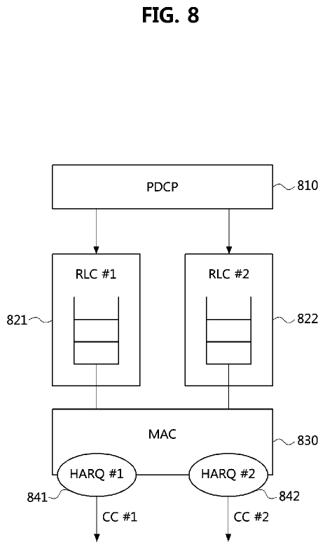

FIG. 8 is a conceptual diagram illustrating an example in which PD is applied to CA.

Referring to FIG. 8, in order to apply PD to CA, a protocol structure may include a PDCP layer 810, RLC layers 821 and 822, a MAC layer 830, and HARQ entities 841 and 842.

In the present exemplary embodiment, a packet duplication entity may be defined in the MAC layer 830 of the vehicle terminal side, and the packet duplication entity may generate a plurality of duplicated MAC PDUs by using one MAC PDU delivered from a multiplexing entity of the MAC layer 830, and deliver them to the HARQ entities 841 and 842 each of which corresponds to a component carrier (CC). In addition, each of the HARQ entities 841 and 842 may transmit the MAC PDU to the receiving side by using an independent redundancy version (RV).

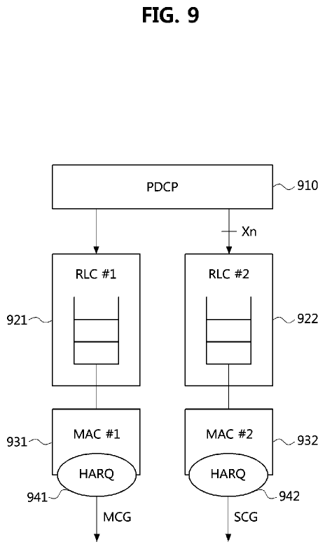

FIG. 9 is a conceptual diagram illustrating an example in which PD is applied to DC.

Referring to FIG. 9, a protocol structure for applying PD to DC may include a PDCP layer 910, RLC layers 921 and 922, MAC layers 931 and 932 and HARQ entities 941 and 942.

In the present exemplary embodiment, data may be duplicated by the PDCP layer 910. Then, one may be transmitted to the receiving side through the RLC layer 921 and the MAC layer 931 of the MCG, and the other may be delivered to the receiving side through the RLC layer 922 and the MAC layer 932 of the SCG.

As described above, in the case of DC, two paths may be configured through the MCG and the SCG, respectively, and in the case of CA, two paths may be configured for component carriers, respectively.

In the high-speed train environment, relay terminals may be installed at the front and at the rear of the train, respectively. The DC-based PD scheme may be applied because the structure in which each relay terminal is connected to a different base station through beamforming is considered.

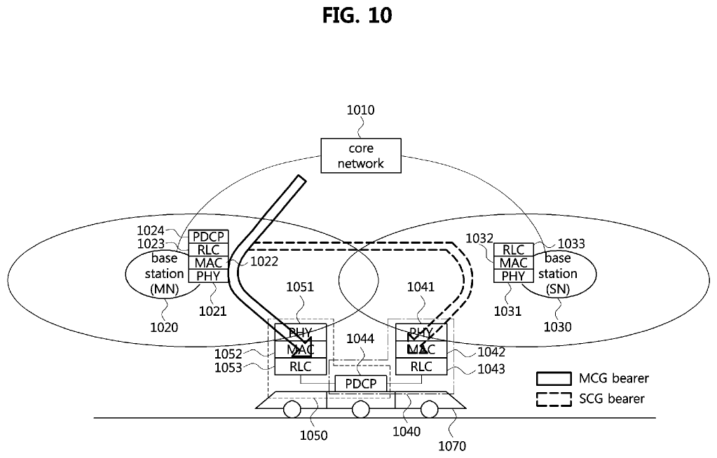

FIG. 10 is a conceptual diagram illustrating a second exemplary embodiment of a communication system.

Referring to FIG. 10, a communication system may include a core network 1010, a plurality of base stations 1020 and 1030, a plurality of relay terminals 1040 and 1050, and a high-speed mobile vehicle 1060. Here, the high-speed mobile vehicle 1060 may be a high-speed train. In addition, the first relay terminal 1040 and the second relay terminal 1050 may constitute a vehicle terminal.

The core network 1010 may be a 5G core network or an EPC, and may be connected to the plurality of base stations 1020 and 1030. Among the plurality of base stations 1020 and 1030, the first base station 1020 may be connected to the second relay terminal 1050, and the second base station 1030 may be connected to the first relay terminal 1040. The first and second base stations 1020 and 1030 may be implemented as gNBs. The first base station 1020 positioned at the rear of the high-speed mobile vehicle 1060 may be an MN, and the second base station 1030 positioned at the front of the high-speed mobile vehicle 1060 may be an SN. Alternatively, the first base station 1020 positioned at the rear of the high-speed mobile vehicle 1060 may be an SN, and the second base station 1030 positioned at the front of the high-speed mobile vehicle 1060 may be an MN.

The first base station 1020 serving as the MN among the base stations 1020 and 1030 may include a physical (PHY) layer 1021, a MAC layer 1022, an RLC layer 1023, and a PDCP layer 1024. The second base station 1030 serving as the SN among the base stations 1020 and 1030 may include a PHY layer 1031, a MAC layer 1032, and an RLC layer 1033. As such, looking at the protocol structure in terms of the network, the first base station 1020 performing MN functions may support a radio access protocol including the PDCP layer 1024 (or, SDAP when connected to 5GC), and the second bae station 1030 performing SN functions may support a radio access protocol including the RLC layer 1033.

The relay terminals 1040 and 1050 may be disposed on the outside of the high-speed train 1060. For example, the first relay terminal 1040 may be disposed on the top of the first vehicle of the high-speed train 1060. In addition, the second relay terminal 1050 may be disposed on the top of the third vehicle of the high-speed train 1060.

The relay terminals 1040 and 1050 may be connected to the base stations 1020 and 1030 through a mobile wireless backhaul network. In this case, the first relay terminal 1040 may be connected to the second base station 1030 serving as the SN through a mobile wireless backhaul link. In addition, the second relay terminal 1050 may be connected to the first base station 1020 serving as the MN through a mobile wireless backhaul link. As such, the second relay terminal 1050 installed in the high-speed train 1070 may be connected to the first base station 1020 performing MN functions, the second relay terminal 1040 may be connected to the second base station 1030 performing SN functions, and radio bearers having the split bearer type may be configured. As such, the bearer type may be a split bearer, and termination points of the bearers may be the first base station 1040 performing MN functions or the second base station 1050 performing SN functions.

Here, the first relay terminal 1040 may support a PHY layer 1041, a MAC layer 1042, an RLC layer 1043, and a PDCP layer 1044. The second relay terminal 1050 may support a PHY layer 1051, a MAC layer 1053, an RLC layer 1053, and the PDCP layer 1044. In this case, the first relay terminal 1040 and the second relay terminal 1050 may share the PDCP layer 1044.

As described above, the radio access protocols (i.e., radio protocol connected with the MN, radio protocol connected with the SN) of the relay terminals 1040 and 1050 may be configured, and the configured radio access protocols may be combined at the PDCP layer 1044. Such the protocol structures may be the same as those defined in MR-DC of 3GPP.

The split bearers may transmit packets in duplicate, if necessary. That is, the split bearers may use the packet duplication transmission scheme in which the same data is transmitted in duplicate, if necessary. This may be a scheme for increasing transmission reliability in the radio section.

In a general mobile communication system, since a quality of a radio link is deteriorated when a handover occurs, the transmission reliability may be deteriorated. The same may be true in the high-speed train environment, and handover occurs frequently due to the mobility of the high-speed train 1060. In the present disclosure, a method of transmitting data using the packet duplication transmission scheme based on split bearers at a time when a handover is highly likely to occur may be considered.

However, if the packet duplication transmission scheme is used, the transmission reliability may be increased, but since the same data is transmitted twice, there may be a disadvantage in that radio resources are wasted. Therefore, according to the present disclosure, the communication system may use the packet duplication transmission scheme only when necessary. To this end, the present disclosure proposes a new condition(s) for initiating and terminating a handover. In addition, the present disclosure proposes a method of applying the packet duplication transmission scheme to a duration in which the condition is satisfied.

In the above-described dual relay-based high-speed train system structure, the second relay terminal 1050 among the two relay terminals 1040 and 1050 may be connected to the first base station 1020 performing MN functions, and the first relay terminal 1040 may be connected to the second base station 1030 performing SN functions. Accordingly, as the high-speed train 1060 moves, the SN and MN may be changed. The 3GPP standard defines a procedure for changing the SN and MN. The change of the MN may be defined as an MN handover, and the change of the SN may be defined as an SN change.

In the dual relay structure, among the first relay terminal 1040 and the second relay terminal 1050, a relay terminal connected to the base station first may establish MN bearers, and a relay terminal connected to the base station later may establish SN bearers. When the first relay terminal 1040 establishes MN bearers and the second relay terminal 1050 establishes SN bearers, the MN handover and the SN change may be repeated as the high-speed train 1060 moves.

On the other hand, when the first relay terminal 1040 establishes SN bearers and the second relay terminal 1050 establishes MN bearers, the SN change and MN handover may be repeated as the high-speed train 1060 moves. That is, according to the structure proposed in the present disclosure, there is no need to define a separate handover procedure, and the procedures defined in the 3GPP standard may be applied as they are.

A method for improving the reliability of wireless backhaul by selectively applying the split transmission scheme and the packet duplication scheme using split bearers in the double relay-based high-speed train system structure may be proposed. The basic concept of this scheme may be described as a scheme in which, in a period where the reliability of the wireless backhaul is low, the relay terminals 1040 and 1050 may transmit data by applying the packet duplication transmission scheme using split bearers, and in other periods, the relay terminals 1040 and 1050 may transmit data by applying the split transmission scheme using split bearers.

For example, the first relay terminal 1040 may measure a quality of a signal received from the second base station 1030, and the second relay terminal 1050 may measure a quality of a signal received from the first base station 1020. Then, the first relay terminal 1040 may share the measured received signal quality of the second base station 1030 by informing it to the second relay terminal 1050, and the second relay terminal 1050 may share the measured received signal quality of the first base station 1020 by informing it to the first relay terminal 1040.

Here, each of the received signal qualities of the first base station 1020 and the second base station 1030 may be at least one of a reference signal received power (RSRP) and a reference signal received quality (RSRQ) thereof.

In the process of splitting and transmitting data using the split bearers, each of the first relay terminal 1040 and the second relay terminal 1050 may compare the received signal qualities of the first base station 1030 and the second base station 1040 with a first threshold value T1. Here, the first relay terminal 1040 and the second relay terminal 1050 may receive information on the first threshold value from the first base station 1020 or the second base station 1030.

When the received signal qualities of the first base station 1020 and the second base station 1030 are less than or equal to the first threshold value T1, the PDCP layer 1044 may generate PDCP PDUs for data to be transmitted when the data to be transmitted exits. In addition, the PDCP layer 1044 may split the PDCP PDUs into first PDCP PDUs to be transmitted to the first base station 1020 and second PDCP PDUs to be transmitted to the second base station 1030. Thereafter, the PDCP layer 1044 may deliver the second PDCP PDUs to be transmitted to the second base station 1030 to the first RLC layer 1043 for a split bearer connected to the second base station 1030. In addition, the PDCP layer 1044 may deliver the first PDCP PDUs to be transmitted to the first base station 1020 to the second RLC layer 1053 for a split bearer connected to the first base station 1020.

Then, the first RLC layer 1043 may transmit the second PDCP PDU to the second base station 1030 through the first MAC layer 1042 and the first PHY layer 1041 for the split bearer connected to the second base station 1030. The second RLC layer 1053 may transmit the first PDCP PDUs to the first base station 1020 through the second MAC layer 1052 and the second PHY layer 1051 for the split bearer connected to the first base station 1020.

In the above-described situation, the PDCP layer 1024 of the first base station 1020 may receive the first PDCP PDUs transmitted by the second relay terminal 1050 through the PHY layer 1021, the MAC layer 1022, and the RLC layer 1023. In addition, the PDCP layer 1024 of the first base station 1020 may receive, from the second base station 1030, the second PDCP PDUs transmitted from the first relay terminal 1040. Then, the PDCP layer 1024 of the first base station 1020 may identify sequence numbers (SNs) of the first PDCP PDUs and the second PDCP PDUs, reassemble them by using the sequence numbers, and deliver the reassembled PDUs to the core network.

On the other hand, in the process of transmitting the data in duplicate by using the split bearers, each of the first relay terminal 1040 and the second relay terminal 1050 may compare the received signal qualities of the first base station 1030 and the second base station 1040 with the first threshold T1. As a result of the comparison, when the received signal qualities of the first relay terminal 1040 and the second relay terminal 1050 exceeds the first threshold T1, the PDCP layer 14044 of the first relay terminal 1040 and the second relay terminal 1050 may generate PDCP PDUs for data to be transmitted. In addition, the PDCP layer 1044 may deliver the PDCP PDUs to the second RLC layer 1053 for the split bearer connected to the first base station 1020, and deliver the same PDCP PDUs to the first RLC layer 1043 for the split bearer connected to the second base station 1030.

Then, the first RLC layer 1043 may duplicate the PDCP PDUs, and deliver the PDCP PDUs to the second base station 1030 through the first MAC layer 1042 and the first PHY layer 1041 for the split bearer connected to the second base station 1030. The second RLC layer 1053 may duplicate the PDCP PDU, and deliver the PDCP PDUs to the first base station 1020 through the second MAC layer 1052 and the second PHY layer 1051 for the split bearer connected to the first base station 1020.

In the above-described situation, the PDCP layer 1024 of the first base station 1020 may receive first PDCP PDUs transmitted by the second relay terminal 1050 through the PHY layer 1021, the MAC layer 1022, and the RLC layer 1023. In addition, the PDCP layer 1024 of the first base station 1020 may receive, from the second base station 1030, the second PDCP PDUs transmitted from the first relay terminal 1040. In this case, the PDCP layer 1024 of the first base station 1020 may identify sequence numbers (SNs) of the first PDCP PDU and the second PDCP PDU. If they are confirmed as the same PDCP PDU, either one may be discarded, and the other PDCP PDU may be delivered to the core network.

As described above, the packet duplication transmission scheme using split bearers is a method of transmitting the same data twice in duplicate, so resources may be wasted. Therefore, it is necessary to minimize execution of the packet duplication transmission scheme only when necessary. Since a period in which the reliability of the wireless backhaul is low may mainly correspond to an area (i.e., handover area) in which a handover is likely to occur, it may be necessary to apply the packet duplication transmission scheme to such the handover area. In addition, in the dual relay structure, the two relay terminals 1040 and 1050 may be disposed apart by a distance corresponding to the length of the train. This may mean that the two relay terminals 1040 and 1050 have different handover timings.

In general, the length of the high-speed train may be regarded as an average of 200 m. When the train speed is 100 km/h, 300 km/h, or 500 km/h, handover occurrence timings of the two relay terminals 1040 and 1050 may have a time difference of 7 seconds, 2.5 seconds, or 1.5 seconds.

Therefore, in the dual relay structure, when a handover occurs in one radio link, a handover may not occur in the other radio link within at least 7 seconds, 2.5 seconds, or 1.5 seconds. In the dual relay structure, a data loss that may occur due to the handover may be prevented and reliability may be improved by performing packet duplication transmission through these two radio links.

Meanwhile, even when the handover is not in progress, it is necessary to apply the packet duplication transmission scheme in advance because the reliability of the radio link is lowered in the vicinity of the position at which the handover occurs. Therefore, the relay terminals 1040 and 1050 may need to determine when to apply the packet duplication transmission scheme. Determining the time point may be regarded as determining a trade-off between the reliability of the radio link and the resource utilization efficiency. That is, if the relay terminals 1040 and 1050 apply the packet duplication transmission scheme in advance, the system may be operated in a direction to improve the reliability, and if the packet duplication transmission scheme is applied later, the system may be operated in a direction to increase the resource utilization efficiency.

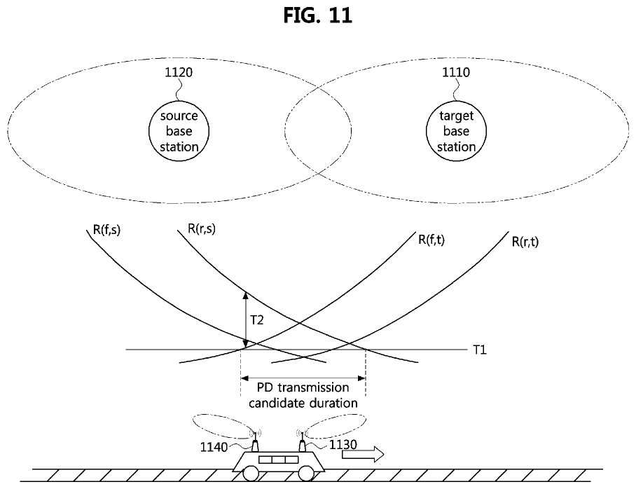

FIG. 11 is a conceptual diagram illustrating radio signal qualities for selectively applying packet duplication transmission in a dual relay-based split bearer scheme.

Referring to FIG. 11, the radio signal qualities for selectively applying the packet duplication transmission scheme to the dual relay-based split bearers may include a received signal quality R(f,t) measured by a first relay terminal 1130 on a reference signal of a target base station 1110 (the same as the second base station 1030 of FIG. 10), a received signal quality R(f,s) measured by the first relay terminal 1130 on a reference signal of a source base station 1120 (the same as the first base station 1020 of FIG. 10), a received signal quality R(r,t) measured by the second relay terminal 1140 on the reference signal of the target base station 1110, and a received signal quality R(r,s) measured by the second relay terminal 1140 on the reference signal of the source base station 1120.

Here, each of the received signal qualities may be at least one of RSRP and RSRQ for the radio signal of the target base station 1110 or the source base station 1120.

These may be summarized as follows.

R(f,t): received signal quality measured by the first relay terminal 1130 on the reference signal transmitted from the target base station 1110

R(f,s): received signal quality measured by the first relay terminal 1130 on to the reference signal transmitted from the source base station 1120

R(r,t): received signal quality measured by the second relay terminal 1140 on the reference signal transmitted from the target base station 1110

R(r,s): received signal quality measured by the second relay terminal 1140 on the reference signal transmitted from the source base station 1120

Using the four received signal quality parameters defined above, the application time of the packet duplication transmission scheme may be derived as follows. When the high-speed train enters the handover area, a handover may occur first in the first relay terminal 1130, and the access base station of the first relay terminal 1130 may be changed from the source base station 1120 to the target base station 1110. Thereafter, as the first relay terminal 1130 exits the handover area, the second relay terminal 1140 may perform a handover, so that the access base station of the second relay terminal 1140 may be changed from the source base station 1120 to the target base station 1110.

Meanwhile, in order to apply the packet duplication transmission scheme, the first relay terminal 1130 and the second relay terminal 1140 may need to be able to create two independent radio links. Therefore, in order to simultaneously configure two radio links in the handover area, the first relay terminal 1130 and the second relay terminal 1140 may have to satisfy the following conditions Equation 2 and Equation 3.

$$\begin{matrix}R ( f , t ) > T 1 & [ Equation 2 ] \\ R ( r , s ) > T 1 & [ Equation 3 ]\end{matrix}$$

These conditions Equation 2 and Equation 3 may be conditions in which a signal outage does not occur in the two radio links in order to apply the packet duplication transmission scheme in the handover area. The duration satisfying the above-described condition may be a duration indicated as a PD transmission candidate duration in FIG. 11. T1, as the first threshold value, and may be appropriately determined by the target base station 1110 or the source base station 1120. The target base station 1110 or the source base station 1120 transmits a message including the first threshold value before transmitting the reference signal to the first relay terminal 1130 and the second relay terminal 1140, thereby delivering configuration information to the first relay terminal 1130 and the second relay terminal 1140. Then, the first relay terminal 1130 and the second relay terminal 1140 may receive and configure the first threshold value from the target base station 1110 or the source base station 1120.

Additionally, the first relay terminal 1130 and the second relay terminal 1140 may transmit data in duplicate by the applying the packet duplication transmission scheme when a condition of Equation 4 is satisfied in addition to the conditions of Equation 2 and Equation 3. That is, when the conditions of Equation 2 to Equation 4 are satisfied, the first relay terminal 1130 and the second relay terminal 1140 may transmit the data in duplicate by applying the packet duplication transmission scheme.

$$R ( r , s ) - R ( f , t ) < T 2 \qquad [ Equation 4 ]$$

Here, T2 may be referred to as a second threshold value. T2 may be appropriately determined by the target base station 1110 or the source base station 1120. The target base station 1110 or the source base station 1120 may transmit a message including the second threshold value before transmitting the reference signal to the first relay terminal 1130 and the second relay terminal 1140, thereby delivering configuration information to the first relay terminal 1130 and the second relay terminal 1140. Then, the first relay terminal 1130 and the second relay terminal 1140 may receive and configure the second threshold value T2 from the target base station 1110 or the source base station 1120.

As shown in FIG. 11, as T2 increases, the duration to which the packet duplication transmission scheme is applied may increase, and as T2 decreases, the duration to which the packet duplication transmission scheme is applied may decrease. Accordingly, the target base station 1110 or the source base station 1120 may configure the second threshold value T2 in consideration of a trade-off between communication reliability and data transmission efficiency according to the wireless backhaul requirements. That is, the minimum value may be selected among T2 values required to secure the reliability to satisfy the wireless backhaul requirements.

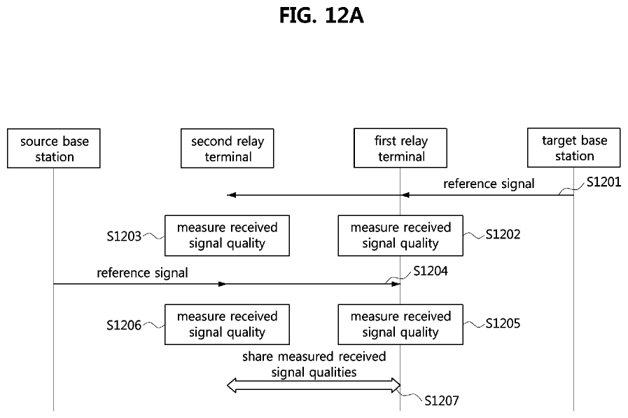

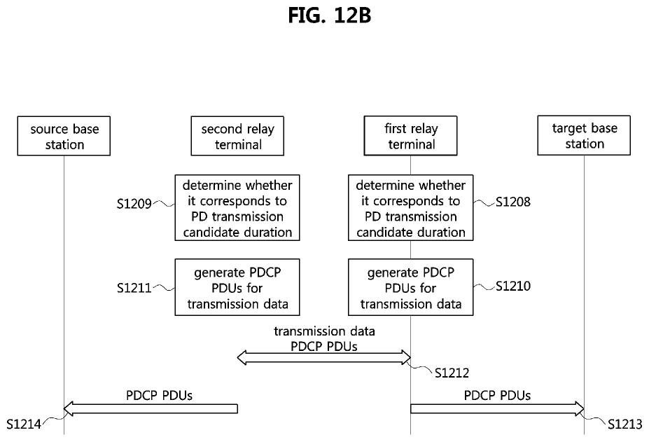

FIGS. 12A and 12B are flowcharts for describing a first exemplary embodiment of a communication method for selectively applying packet duplication transmission in a dual relay-based split bearer scheme.

Referring to FIGS. 12A and 12B, in a communication method for selectively applying the packet duplication transmission in the dual relay-based split bearer scheme, the first relay terminal may receive a reference signal from the target base station (S1201), and measure a received signal quality R(f,t) (S1202). In addition, the first relay terminal may receive a reference signal from the source base station (S1204), and measure a received signal quality R(f,s) (S1205). Similarly, the second relay terminal may receive a reference signal from the target base station (S1201), and measure a received signal quality R(r,t) (S1203). In addition, the second relay terminal may receive a reference signal from the source base station (S1204), and measure a received signal quality R(r,s) (S1206).

Here, each of the received signal qualities may be at least one of RSRP, RSRQ, and a combination thereof with respect to the reference signal of the target base station or the source base station.

The first relay terminal may transmit, to the second relay terminal, information on the received signal quality R(f,t) measured by receiving the reference signal from the target base station and the received signal quality R(f,s) measured by receiving the reference signal from the source base station, thereby sharing the received signal qualities R(f,t) and R(f,s) with the second relay terminal (S1207). In addition, similarly, the second relay terminal may transmit, to the first relay terminal, information on the received signal quality R(r,t) measured by receiving the reference signal from the target base station and the received signal quality R(r,s) measured by receiving the reference signal from the source base station, thereby sharing the received signal qualities R(r,t) and R(r,s) with the first relay terminal (S1207).

Accordingly, in the first relay terminal, the received signal quality R(f,t) may satisfy Equation 2, and the received signal quality R(r,s) may satisfy Equation 3, so that it may be determined whether to perform the packet duplication transmission scheme (S1208). That is, it may be determined whether the current time corresponds to a PD transmission candidate duration. Similarly, in the second relay terminal, the received signal quality R(f,t) may satisfy Equation 2, and the received signal quality R(r,s) may satisfy Equation 3, so that it may be determined whether to perform the packet duplication transmission scheme (S1209). That is, it may be determined whether the current time corresponds to a PD transmission candidate duration.

As a result of the determination of the first relay terminal, if there is transmission data to be transmitted and the current time corresponds to the PD transmission candidate duration, the PDCP layer common to the first relay terminal and the second relay terminal may generate PDCP PDUs of the corresponding transmission data (S1210). In addition, the PDCP layer may deliver the PDCP PDUs to the RLC layer of the first relay terminal for the split bearer connected to the target base station, and deliver the same PDCP PDUs to the RLC layer of the second relay terminal for the split bearer connected to the source base station (S1212).

Then, the RLC layer of the first relay terminal may duplicate the PDCP PDU, and may transmit the duplicated PDCP PDU to the target base station through the MAC layer and the PHY layer of the first relay terminal for the split bearer connected to the target base station (S1213). Similarly, the RLC layer of the second relay terminal may duplicate the PDCP PDU, and may transmit the duplicated PDCP PDU to the source base station through the MAC layer and the PHY layer of the second relay terminal for the split bearer connected to the source base station (S1214).

On the other hand, as a result of the determination of the second relay terminal, if there is transmission data to be transmitted and the current time corresponds to the PD transmission candidate duration, the PDCP layer common to the first relay terminal and the second relay terminal may generate PDCP PDUs of the corresponding transmission data (S1211). In addition, the PDCP layer may deliver the PDCP PDUs to the RLC layer of the first relay terminal for the split bearer connected to the target base station (S1212), and deliver the same PDCP PDUs to the RLC layer of the second relay terminal for the split bearer connected to the source base station.

Then, the RLC layer of the first relay terminal may duplicate the PDCP PDU, and may transmit the PDCP PDUs to the target base station through the MAC layer and the PHY layer of the first relay terminal for the split bearer connected to the target base station (S1213). Similarly, the RLC layer of the second relay terminal may duplicate the PDCP PDU, and may transmit the PDCP PDUs to the source base station through the MAC layer and the PHY layer of the second relay terminal for the split bearer connected to the source base station (S1214).

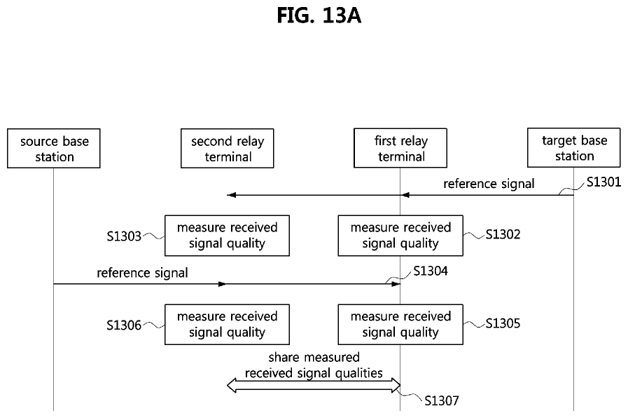

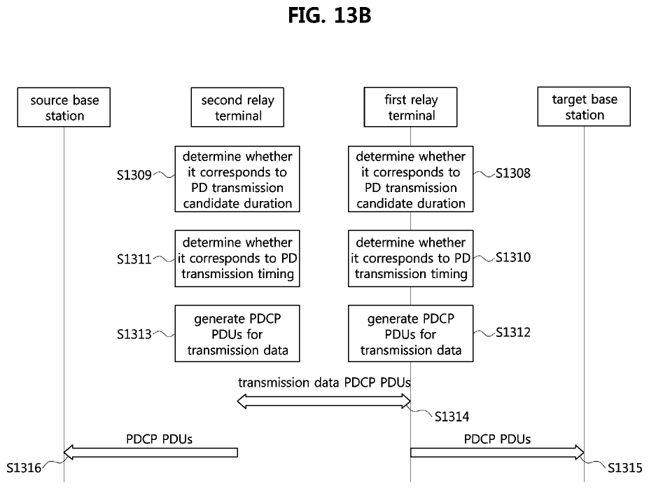

FIGS. 13A and 13B are flowcharts for describing a second exemplary embodiment of a communication method for selectively applying packet duplication transmission in a dual relay-based split bearer scheme.

Referring to FIGS. 13A and 13B, in a communication method for selectively applying the packet duplication transmission scheme in the dual relay-based split bearer scheme, the first relay terminal may receive a reference signal from a target base station (S1301), and measure a received signal quality R(f,t) (S1302). In addition, the first relay terminal may receive a reference signal from a source base station (S1304), and measure a received signal quality R(f,s) (S1305). Similarly, the second relay terminal may receive the reference signal from the target base station (S1301), and measure a received signal quality R(r,t) (S1303). In addition, the second relay terminal may receive the reference signal from the source base station (S1304), and measure a received signal quality R(r,s) (S1306).

Here, each of the received signal qualities may be at least one of RSRP, RSRQ, and a combination thereof with respect to the reference signal of the target base station or the source base station.

The first relay terminal may transmit, to the second relay terminal, information on the received signal quality R(f,t) measured by receiving the reference signal from the target base station and the received signal quality R(f,s) measured by receiving the reference signal from the source base station, thereby sharing the received signal qualities R(f,t) and R(f,s) with the second relay terminal (S1307). In addition, similarly, the second relay terminal may transmit, to the first relay terminal, information on the received signal quality R(r,t) measured by receiving the reference signal from the target base station and the received signal quality R(r,s) measured by receiving the reference signal from the source base station, thereby sharing the received signal qualities R(r,t) and R(r,s) with the first relay terminal (S1307).

Accordingly, in the first relay terminal, the received signal quality R(f,t) may satisfy Equation 2, and the received signal quality R(r,s) may satisfy Equation 3, so that it may be determined whether to perform the packet duplication transmission scheme (S1308). That is, it may be determined whether the current time corresponds to a PD transmission candidate duration. Similarly, in the second relay terminal, the received signal quality R(f,t) may satisfy Equation 2, and the received signal quality R(r,s) may satisfy Equation 3, so that it may be determined whether to perform the packet duplication transmission scheme (S1309). That is, it may be determined whether the current time corresponds to a PD transmission candidate duration.

As a result of the determination, if the current time corresponds to the PD transmission candidate duration, the first relay terminal may identify whether the received signal quality R(f,t) and the received signal quality R(r,s) satisfy the condition of Equation 4 to determine whether the current time corresponds to a packet duplication transmission timing (S1310). As a result of the determination, if there is transmission data to be transmitted and the current time corresponds to the packet duplication transmission timing, the PDCP layer common to the first relay terminal and the second relay terminal may generate PDCP PDUs of the corresponding transmission data (S1312). In addition, the PDCP layer may deliver the PDCP PDUs to the RLC layer of the first relay terminal for the split bearer connected to the target base station, and deliver the same PDCP PDUs to the RLC layer of the second relay terminal for the split bearer connected to the source base station (S1314).

Then, the RLC layer of the first relay terminal may duplicate the PDCP PDU, and may transmit the PDCP PDUs to the target base station through the MAC layer and the physical layer of the first relay terminal for the split bearer connected to the target base station (S1315). Similarly, the RLC layer of the second relay terminal may duplicate the PDCP PDU, and may transmit the PDCP PDUs to the source base station through the MAC layer and the PHY layer of the second relay terminal for the split bearer connected to the source base station (S1316).

On the other hand, as a result of the determination of the second relay terminal, it may be identified whether the received signal quality R(f,t) and the received signal quality R(r,s) satisfy the condition of Equation 4 to determine whether the current time corresponds to a packet duplication transmission timing (S1311). As a result of the determination, if there is transmission data to be transmitted and the current time corresponds to the packet duplication transmission timing, the PDCP layer common to the first relay terminal and the second relay terminal may generate PDCP PDUs of the corresponding transmission data (S1313). In addition, the PDCP layer may deliver the PDCP PDUs to the RLC layer of the first relay terminal for the split bearer connected to the target base station, and deliver the same PDCP PDUs to the RLC layer of the second relay terminal for the split bearer connected to the source base station (S1314).

Then, the RLC layer of the first relay terminal may duplicate the PDCP PDU, and may transmit the PDCP PDUs to the target base station through the MAC layer and the PHY layer of the first relay terminal for the split bearer connected to the target base station (S1315). Similarly, the RLC layer of the second relay terminal may duplicate the PDCP PDU, and may transmit the PDCP PDUs to the source base station through the MAC layer and the PHY layer of the second relay terminal for the split bearer connected to the source base station (S1316).

Meanwhile, although only the uplink has been described herein, the same procedure may be applied to the downlink. To this end, the relay terminals may measure received signal strengths of signals received from the base stations, and report the measured values to the base stations. Then, the PDCP of the base station (MN) may perform packet duplication according to the condition of the measured values.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal including a first relay and a second relay, in a communication system, the operation method comprising:
measuring, by the first relay, a first received signal quality of a first base station connected to the first relay;
measuring, by the second relay, a second received signal quality of a second base station connected to the second relay;
transmitting, by the first relay, a first protocol data unit (PDU) to the first base station based on the first received signal quality and the second received signal quality through a first bearer established in the first relay; and
transmitting, by the second relay, a second PDU to the second base station based on the first received signal quality and the second received signal quality through a second bearer established in the second relay.

2. The operation method according to claim 1, wherein each of the first relay and the second relay perform functions of a radio link control (RLC) layer, a medium access control (MAC) layer, and a physical (PHY) layer, the first relay and the second relay share functions of a packet data convergence protocol (PDCP) layer, and the first bearer and the second bearer are split bearers.

3. The operation method according to claim 1, wherein when a packet duplication transmission scheme is used, the first PDU is equal to the second PDU, and when a split transmission scheme is used, the first PDU is different from the second PDU.

4. The operation method according to claim 1, wherein each of the first received signal quality and the second received signal quality is one of a reference signal received power (RSRP) and a reference signal received quality (RSRQ) for a reference signal, the first base station is a master node, and the second base station is a secondary node.

5. The operation method according to claim 1, wherein when the first received signal quality and the second received signal quality are less than or equal to a first threshold, the first PDU transmitted from the first relay to the first base station is different from the second PDU transmitted from the second relay to the second base station.

6. The operation method according to claim 1, wherein when the first received signal quality and the second received signal quality exceed a first threshold, the first PDU transmitted from the first relay to the first base station is equal to the second PDU transmitted from the second relay to the second base station.

7. The operation method according to claim 1, wherein when the first received signal quality and the second received signal quality exceed a first threshold and a value obtained by subtracting the first received signal quality from the second received signal quality is less than a second threshold, the first PDU transmitted from the first relay to the first base station is equal to the second PDU transmitted from the second relay to the second base station.

8. An operation method of a first base station in a communication system, the operation method comprising:
transmitting a first reference signal;
receiving a first protocol data unit (PDU) from a first relay based on a first received signal quality of the first reference signal; and
receiving, from a second base station, a second PDU received by the second base station from a second relay based on a second received signal quality of a second reference signal transmitted from the second base station,
wherein when the first received signal quality at the first relay and the second received signal quality at the second relay are less than or equal to a first threshold, the first PDU and the second PDU are different, and when the first received signal quality and second received signal quality exceeds the first threshold, the first PDU and the second PDU are same.

9. The operation method according to claim 8, further comprising transmitting a message including the first threshold before transmitting the first reference signal.

10. The operation method according to claim 8, further comprising when the first PDU is same as the second PDU, selecting one among the first PDU and the second PDU, and transmitting the one to a core network, and when the first PDU is different from the second PDU, reassembling the first PDU and the second PDU, and transmitting the reassembled PDUs to the core network.

11. A terminal comprising:
a processor;
a memory electronically communicating with the processor; and
instructions stored in the memory,
wherein when executed by the processor, the instructions cause the terminal to:
measure, by the first relay, a first received signal quality of a first base station connected to the first relay;
measure, by the second relay, a second received signal quality of a second base station connected to the second relay;
transmit, by the first relay, a first protocol data unit (PDU) to the first base station based on the first received signal quality and the second received signal quality through a first bearer established in the first relay; and
transmit, by the second relay, a second PDU to the second base station based on the first received signal quality and the second received signal quality through a second bearer established in the second relay.

12. The terminal according to claim 11, wherein when the first received signal quality and the second received signal quality exceed a first threshold, the first PDU transmitted from the first relay to the first base station is equal to the second PDU transmitted from the second relay to the second base station.

13. The terminal according to claim 11, wherein when the first received signal quality and the second received signal quality exceed a first threshold and a value obtained by subtracting the first received signal quality from the second received signal quality is less than a second threshold, the first PDU transmitted from the first relay to the first base station is equal to the second PDU transmitted from the second relay to the second base station.
